(19) United States
(12) Patent Application Publication
(10) Pub. No.: US 2018/0124690 A1
(43) Pub. Date: May 3, 2018

(54) Access Processing Method and Apparatus

(71) Applicant: Huawei Technologies Co., Ltd., Shenzhen (CN)

(72) Inventors: Xiuping Zhang, Shenzhen (CN); Te-Chin Chang, Shenzhen (TW); Weihua Deng, Shenzhen (CN)

(21) Appl. No.: 15/565,349

(22) PCT Filed: Apr. 7, 2015
(86) PCT No.: PCT/CN2015/076010

§ 371 Date: Oct. 9, 2017

(51) Int. Cl. H04W 48/16; H04W 24/04; H04L 12/24

(52) U.S. Cl. CPC H04W 48/16; H04W 48/20; H04L 41/14; H04W 24/04

(57) ABSTRACT

Embodiments of the present disclosure disclose an access processing method. The access processing method includes when it is detected that a target network access point cannot access a network in previous network access detection that is closest to a current moment, obtaining network access information of the target network access point before the previous network access detection; analyzing the network access information to determine whether the target network access point has a network access capability; and if the target network access point has the network access capability, automatically accessing the target network access point, and detecting whether the target network access point can currently access the network. Embodiments of the present disclosure further disclose an access processing apparatus. By using the present disclosure, filtering out, because of erroneous determining, a target network access point that can access a network is avoided, and accuracy of network access detection is improved.

### CROSS-REFERENCE TO RELATED APPLICATIONS

This application is a National Stage of International Application No. PCT/CN2015/076010, filed on Apr. 7, 2015, which is hereby incorporated by reference in its entirety.

### TECHNICAL FIELD

The present disclosure relates to the field of wireless network technologies, and in particular, to an access processing method and apparatus.

### BACKGROUND

In a wireless fidelity (Wi-Fi) network, a terminal accesses a network by using a network access point (AP). Each time before the terminal enables Wi-Fi and accesses a network by using an AP, the terminal needs to perform network access detection to check whether the AP can access the network. If a detection result is that the AP can access the network, the terminal accesses the network by using the AP. If a detection result is that the AP cannot access the network, the terminal searches for another AP. In some approaches, to provide relatively good experience for a user and reduce network access time, before performing network access detection, the terminal automatically filters out an AP that is determined incapable of accessing a network, that is, automatic network access detection is not performed subsequently on an AP that is determined incapable of accessing a network, unless the user manually taps to access the AP. In some approaches, a method used by a terminal to filter out an AP that is determined incapable of accessing a network is obtaining a detection result for the AP in previous network access detection, and if the AP cannot access a network previously, determining that the AP cannot access a network and automatically filtering out the AP so that the AP is not automatically accessed subsequently any more. If the AP can access a network previously, the AP is automatically accessed and network access detection is performed.

However, because of network congestion or terminal hardware stability, a small probability of erroneous determining may exist in network access detection, that is, an AP that can access a network is detected as an AP that cannot access a network. According to some approaches, an AP filtering manner of considering only a previous network access detection result may cause a filtering error, because if the AP is erroneously determined in previous network access detection, the terminal does not automatically access the AP subsequently any more. As a result, the AP that can access a network is filtered out forever, leading to extremely low accuracy of network access detection and affecting user experience.

### SUMMARY

Embodiments of the present disclosure provide an access processing method and apparatus, so as to avoid filtering out, because of erroneous determining, a target network access point that can access a network, and improve accuracy of network access detection.

A first aspect of the present disclosure provides an access processing method, including when it is detected that a target network access point cannot access a network in previous network access detection that is closest to a current moment, obtaining network access information of the target network access point before the previous network access detection; analyzing the network access information to determine whether the target network access point has a network access capability; and if the target network access point has the network access capability, automatically accessing the target network access point, and detecting whether the target network access point can currently access the network.

Based on the first aspect, in a first feasible implementation manner, the network access information includes at least one network access detection record entry before the previous network access detection, and the network access detection record entry is a successful record entry or an unsuccessful record entry.

Based on the first feasible implementation manner of the first aspect, in a second feasible implementation manner, the analyzing the network access information to determine whether the target network access point has a network access capability includes determining whether the network access information includes an unsuccessful record entry; and if the network access information does not include an unsuccessful record entry, determining that the target network access point has the network access capability.

Based on the second feasible implementation manner of the first aspect, in a third feasible implementation manner, after the determining whether the network access information includes an unsuccessful record entry, the method further includes if the network access information includes an unsuccessful record entry, obtaining, in the network access information, a preset quantity of network access detection record entries that are adjacent to the previous network access detection; and if the preset quantity of network access detection record entries are all successful record entries, determining that the target network access point has the network access capability.

Based on the third feasible implementation manner of the first aspect, in a fourth feasible implementation manner, after the obtaining, in the network access information, a preset quantity of network access detection record entries that are adjacent to the previous network access detection, the method further includes if the preset quantity of network access detection record entries include an unsuccessful record entry, counting a percentage of a successful record entry in the network access information; and if the percentage is greater than a preset threshold, determining that the target network access point has the network access capability.

A second aspect of the present disclosure provides an access processing apparatus, including an obtaining module configured to when it is detected that a target network access point cannot access a network in previous network access detection that is closest to a current moment, obtain network access information of the target network access point before the previous network access detection; an analysis module configured to analyze the network access information to determine whether the target network access point has a network access capability; and a detection module configured to if the target network access point has the network access capability, automatically access the target network access point, and detect whether the target network access point can currently access the network.

Based on the second aspect, in a first feasible implementation manner, the network access information includes at least one network access detection record entry before the previous network access detection, and the network access detection record entry is a successful record entry or an unsuccessful record entry.

Based on the first feasible implementation manner of the second aspect, in a second feasible implementation manner, the analysis module includes a judging unit configured to determine whether the network access information includes an unsuccessful record entry; and a first determining unit configured to if the network access information does not include an unsuccessful record entry, determine that the target network access point has the network access capability.

Based on the second feasible implementation manner of the second aspect, in a third feasible implementation manner, the analysis module further includes an obtaining unit configured to if the network access information includes an unsuccessful record entry, obtain, in the network access information, a preset quantity of network access detection record entries that are adjacent to the previous network access detection; and a second determining unit configured to if the preset quantity of network access detection record entries are all successful record entries, determine that the target network access point has the network access capability.

Based on the third feasible implementation manner of the second aspect, in a fourth feasible implementation manner, the analysis module further includes: a counting unit configured to if the preset quantity of network access detection record entries include an unsuccessful record entry, count a percentage of a successful record entry in the network access information; and a third determining unit configured to if the percentage is greater than a preset threshold, determine that the target network access point has the network access capability.

In the embodiments of the present disclosure, when it is detected that a target network access point cannot access a network in previous network access detection that is closest to a current moment, network access information of the target network access point before the previous network access detection is obtained; the network access information is analyzed to determine whether the target network access point has a network access capability; and if the target network access point has the network access capability, the target network access point is automatically accessed, and it is detected whether the target network access point can currently access the network. In this implementation manner, when it is detected that the target network access point cannot access the network in the previous network access detection, the target network access point is not filtered out directly. The network access information before the previous network access detection is further analyzed to determine whether to perform network access detection on the target network access point. Therefore, in this manner, filtering out, because of erroneous determining, a target network access point that can access a network is avoided, and accuracy of network access detection is improved.

### BRIEF DESCRIPTION OF DRAWINGS

To describe the technical solutions in the embodiments of the present disclosure more clearly, the following briefly describes the accompanying drawings for describing the embodiments. The accompanying drawings in the following description show merely some embodiments of the present disclosure, and persons of ordinary skill in the art may still derive other drawings from these accompanying drawings without creative efforts.

FIG. 1 is a schematic flowchart of an access processing method according to an embodiment of the present disclosure;

FIG. 2A and FIG. 2B are a schematic flowchart of another access processing method according to an embodiment of the present disclosure;

FIG. 3 is a schematic diagram of a network access detection record entry according to an embodiment of the present disclosure;

FIG. 4 is a schematic structural diagram of an access processing apparatus according to an embodiment of the present disclosure;

FIG. 5 is a schematic structural diagram of an analysis module according to an embodiment of the present disclosure; and

FIG. 6 is a schematic structural diagram of another access processing apparatus according to an embodiment of the present disclosure.

### DESCRIPTION OF EMBODIMENTS

The following describes the technical solutions in the embodiments of the present disclosure with reference to the accompanying drawings in the embodiments of the present disclosure. The described embodiments are merely some but not all of the embodiments of the present disclosure. All other embodiments obtained by persons of ordinary skill in the art based on the embodiments of the present disclosure shall fall within the protection scope of the present disclosure.

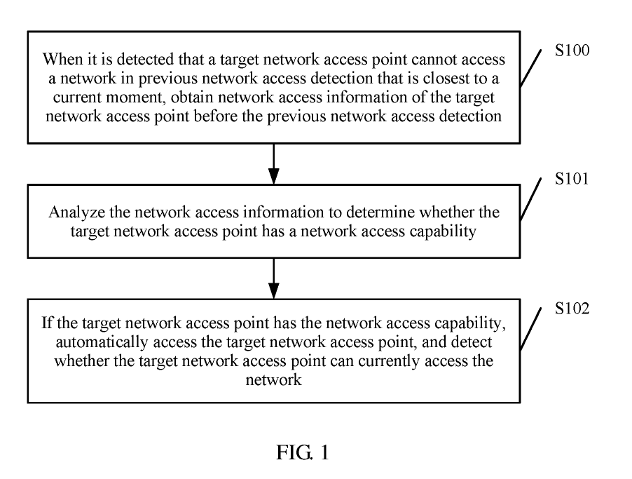

Referring to FIG. 1, FIG. 1 is a schematic flowchart of an access processing method according to an embodiment of the present disclosure. As shown in FIG. 1, the access processing method in this embodiment includes steps S100 to S102.

S100. When it is detected that a target network access point cannot access a network in previous network access detection that is closest to a current moment, obtain network access information of the target network access point before the previous network access detection.

In this embodiment of the present disclosure, a target AP may be any AP for which a terminal pre-stores an AP identifier. Before accessing a network by using the target AP, the terminal needs to perform network access detection on the target AP, that is, detect whether the target AP can access a network. When it is detected that the target AP cannot access a network, the terminal searches for another AP in a preset distance range, or if the target AP can access a network, the terminal accesses the network by using the target AP. In an embodiment, to provide relatively good experience for a user and reduce network access time, before performing network access detection, the terminal automatically filters out an AP that is determined incapable of accessing a network, that is, automatic network access detection is not performed subsequently on an AP that is determined incapable of accessing a network, unless the user manually taps to access the AP. Generally, a method used by a terminal to filter out an AP that is determined incapable of accessing a network is obtaining a detection result for the AP in previous network access detection, and if the AP cannot access a network previously, determining that the AP cannot access a network and automatically filtering out the AP so that the AP is not automatically accessed subsequently any more. If the AP can access a network previously, the AP is automatically accessed and network access detection is performed.

However, because of network congestion or terminal hardware stability, a small probability of erroneous determining may exist in network access detection, that is, an AP that can access a network is detected as an AP that cannot access a network. If it is detected, in network access detection, that an AP cannot access a network, this does not absolutely indicate that the AP is unavailable. Because erroneous determining may exist, considering only a previous network access detection result may cause extremely low accuracy of network access detection.

To resolve the foregoing problem, this embodiment of the present disclosure provides an access processing method, so that a target AP that may be erroneously determined has an opportunity for being reselected for access, and network access detection is re-initiated.

In this embodiment of the present disclosure, a terminal enables Wi-Fi. When it is detected that a target AP cannot access a network in previous network access detection that is closest to a current moment, network access information of the target AP before the previous network access detection is obtained. The network access information can indicate multiple network access detection records of the target AP before the previous network access detection, such as whether a network is successfully accessed by using the target AP, or access duration of accessing the network by using the target AP. It should be noted that the network access information may be stored in a newly-added field of a network attribute database of the terminal.

S101. Analyze the network access information to determine whether the target network access point has a network access capability.

In this embodiment of the present disclosure, the obtained network access information is analyzed to further determine whether the target AP has the network access capability. If the target AP has the network access capability, the previous network access detection may be erroneous determining. An analysis method for analyzing the network access information may be determined according to an existing form of the network access information. For example, if the network access information includes multiple network access detection record entries that are used to indicate whether the target AP successfully accesses the network in a detection process before the previous network access detection, an analysis process of analyzing the network access information may be determining whether the network access detection record entries are all successful record entries of successfully accessing the network. If the network access detection record entries are all successful record entries, it is most likely that the previous network access detection is erroneous determining, and the target AP has the network access capability. Further, if the network access detection record entries include an unsuccessful record entry of unsuccessfully accessing the network, a preset quantity of network access detection record entries that are adjacent to the previous network access detection may be obtained. If the preset quantity of network access detection record entries are all successful record entries, it indicates that the previous network access detection may be erroneous determining, and it is determined that the target AP has the network access capability. Still further, if the preset quantity of network access detection record entries include an unsuccessful record entry, a percentage of a successful record entry in all the network access detection record entries may be counted. If the percentage is greater than a preset threshold (such as 50%), it is also determined that the target AP has the network access capability, and the previous network access detection may be erroneous determining.

It should be noted that an analysis manner of analyzing the network access information to determine whether the target AP has the network access capability is not limited to the foregoing example. For example, if the network access information is network access duration of the target AP before the previous network access detection, the analysis manner may further be analyzing the network access duration in the network access information, so as to determine whether the target AP has the network access capability.

S102. If the target network access point has the network access capability, automatically access the target network access point, and detect whether the target network access point can currently access the network.

In this embodiment of the present disclosure, if an analysis result of analyzing the network access information indicates that the target AP has the network access capability, the target AP is automatically accessed, and it is detected whether the target AP can currently access the network. If the target AP can currently access the network, the network is accessed by using the target AP, or if the target AP cannot access the network, another AP is searched for, network access detection is performed on the another AP, and a result of the network access detection is stored so as to be used next time a terminal enables Wi-Fi to filter out an AP.

By using this embodiment of the present disclosure, although the target AP is erroneously determined in network access detection, and it is detected that the target AP cannot access a network, the target AP may not be filtered out directly in a subsequent phase of automatically accessing an AP. The network access information of the target AP before the previous network access detection is analyzed to determine whether the target AP has the network access capability. When it is detected that the target AP has the network access capability, the target AP may also be automatically accessed, and network access detection is performed on the target AP, that is, an error tolerance and recovery method is provided for the target AP.

In this embodiment of the present disclosure, when it is detected that a target network access point cannot access a network in previous network access detection that is closest to a current moment, network access information of the target network access point before the previous network access detection is obtained; the network access information is analyzed to determine whether the target network access point has a network access capability; and if the target network access point has the network access capability, the target network access point is automatically accessed, and it is detected whether the target network access point can access the network. In this implementation manner, when it is detected that the target network access point cannot access the network in the previous network access detection, the target network access point is not filtered out directly. The network access information before the previous network access detection is further analyzed to determine whether to perform network access detection on the target network access point. Therefore, in this manner, filtering out, because of erroneous determining, a target network access point that can access a network is avoided, and accuracy of network access detection is improved.

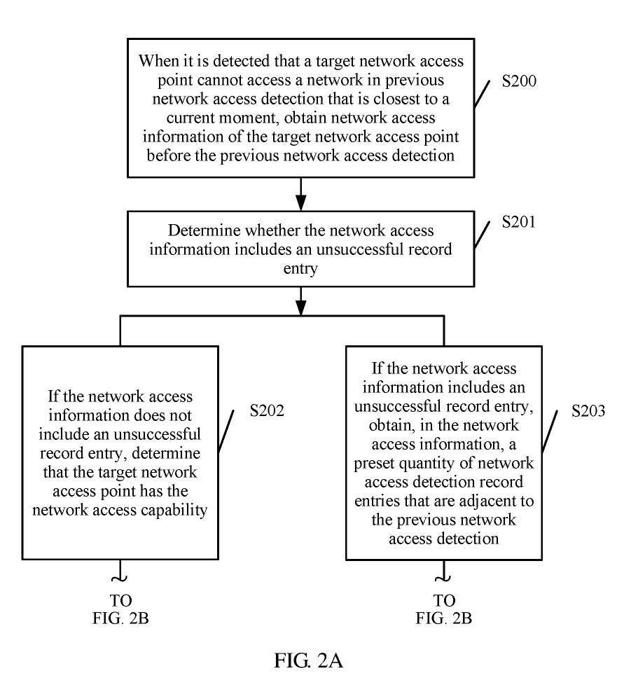

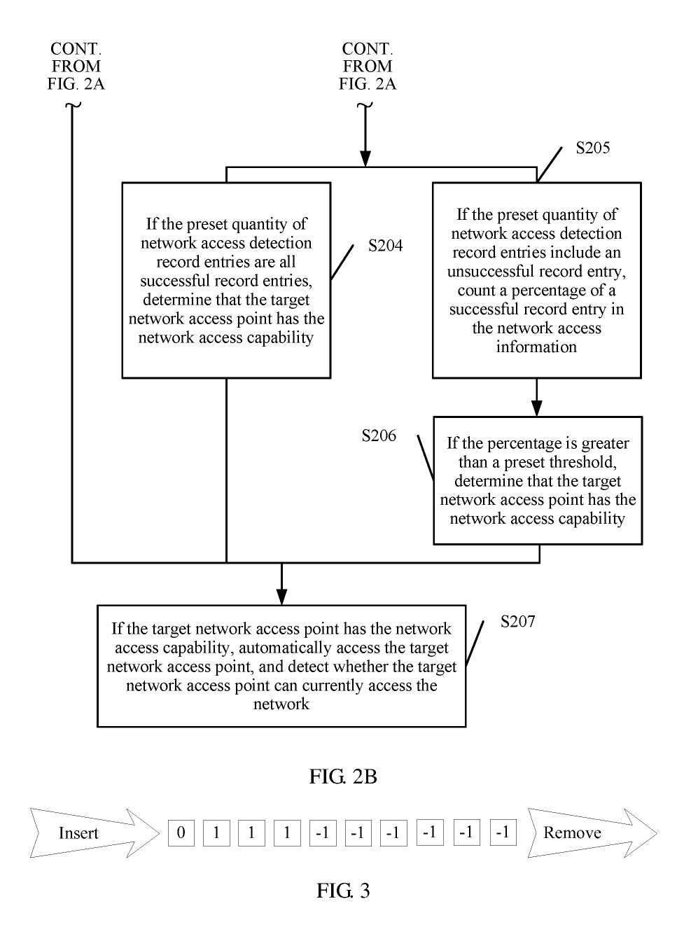

Referring to FIG. 2A and FIG. 2B, FIG. 2A and FIG. 2B are a schematic flowchart of another access processing method according to an embodiment of the present disclosure. As shown in FIG. 2A and FIG. 2B, the access processing method provided in this embodiment includes steps S200 to S207.

S200. When it is detected that a target network access point cannot access a network in previous network access detection that is closest to a current moment, obtain network access information of the target network access point before the previous network access detection.

In this embodiment of the present disclosure, the network access information of the target network access point before the previous network access detection may include at least one network access detection record entry before the previous network access detection. The network access detection record entry is used to indicate whether the target AP successfully accesses the network in a network access detection record before the previous network access detection, and the network access detection record entry is a successful record entry or an unsuccessful record entry. In this embodiment of the present disclosure, all historical detection record entries may be stored by using a newly-added field in a network attribute database, and all the historical detection record entries include a detection result of the previous network access detection and the network access detection record entry before the previous network access detection. As shown in FIG. 3, a newly-added field INTERNET_HISTORY is provided in this embodiment of the present disclosure to store all the historical detection record entries. The newly-added field records a maximum of 10 historical detection record entries in total, which may be INTERNET_HISTORY: 0/1/1/1/−1/−1/−1/−1/−1/−1, where on the left is a recent detection result (that is, the detection result of the previous network access detection), and on the right is a farthest detection result. 0 represents that the target AP cannot access the network in network access detection, 1 represents that the target AP can access the network in network access detection, and −1 represents that detection is not performed (there are all −1 in an initial list). In an algorithm, an array may be used to store all the historical detection record entries. For example, h[0] is used to represent a previous detection result, and h[1 . . . 9] is the network access detection record entry before the previous network access detection. Generally, when h[0] is 0, that is, when it is detected that the target AP cannot access the network previously, a subsequent step of obtaining the network access information of the target AP before the previous network access detection is performed.

S201. Determine whether the network access information includes an unsuccessful record entry.

In this embodiment of the present disclosure, to determine whether the target AP has the network access capability, it is determined whether the network access information before the previous network access detection includes an unsuccessful record entry. Here, an example in which h[1 . . . 9] is the network access detection record entry in the network access information is still used for description. That is, the network access detection record entry h[1 . . . 9] is traversed from left to right, to obtain a quantity w (w is greater than or equal to 1) of network access detection record entries whose values are not −1 in the array h[1 . . . 9], and determine whether there are all 1 in arrays h[1] to h[w].

S202. If the network access information does not include an unsuccessful record entry, determine that the target network access point has the network access capability.

In this embodiment of the present disclosure, if none of the network access detection record entries in the network access information includes an unsuccessful record entry, it is determined that the target AP has the network access capability, that is, if there are all 1 in the arrays h[1] to h[w], it is determined that the target AP has the network access capability.

S203. If the network access information includes an unsuccessful record entry, obtain, in the network access information, a preset quantity of network access detection record entries that are adjacent to the previous network access detection.

In this embodiment of the present disclosure, if the network access detection record entries in the network access information include an unsuccessful record entry, that is, the arrays h[1] to h[w] include 0, the preset quantity of network access detection record entries that are adjacent to the previous network access detection are obtained. In the network access information, the network access detection record entries are arranged according to a detection time sequence, and the preset quantity of network access detection record entries that are adjacent to the previous network access detection are a preset quantity of network access detection record entries for recent detection except the previous network access detection. The preset quantity may be determined according to a condition, for example, the preset quantity may be two, and values of h[1] and h[2] in the array are obtained.

S204. If the preset quantity of network access detection record entries are all successful record entries, determine that the target network access point has the network access capability.

In this embodiment of the present disclosure, if the obtained the preset quantity of network access detection record entries are all successful record entries, it is determined that the target AP has the network access capability. If the preset quantity is n (n is less than or equal to w), that is, when h[1] to h[n] are all 1, it is determined that the target AP has the network access capability.

S205. If the preset quantity of network access detection record entries include an unsuccessful record entry, count a percentage of a successful record entry in the network access information.

In this embodiment of the present disclosure, when the preset quantity of network access detection record entries that are adjacent to the previous network access detection include an unsuccessful record entry, that is, 0 exists in the arrays h[1] to h[n], a percentage of a successful record entry in the network access information is counted. A counting method may be calculating a quantity w of network access detection record entries in the network access information, that is, calculating a quantity of values that are not −1 in the array h[1 . . . 9], and calculating a quantity m of successful record entries in the network access information, that is, calculating a quantity of values 1 in the array h[1 . . . 9], and the percentage P of a successful record entry is m/w.

S206. If the percentage is greater than a preset threshold, determine that the target network access point has the network access capability.

In this embodiment of the present disclosure, if the calculated percentage P is greater than the preset threshold, it is determined that the target AP has the network access capability. The preset threshold may be set according to a condition, for example, may be 60%, or may be 50%.

S207. If the target network access point has the network access capability, automatically access the target network access point, and detect whether the target network access point can currently access the network.

For step S207 in this embodiment of the present disclosure, refer to step S102 in the embodiment in FIG. 1, and details are not described herein again.

In this embodiment of the present disclosure, when it is detected that a target network access point cannot access a network in previous network access detection that is closest to a current moment, network access information of the target network access point before the previous network access detection is obtained; the network access information is analyzed to determine whether the target network access point has a network access capability; and if the target network access point has the network access capability, the target network access point is automatically accessed, and it is detected whether the target network access point can currently access the network. In this implementation manner, when it is detected that the target network access point cannot access the network in the previous network access detection, the target network access point is not filtered out directly. The network access information before the previous network access detection is further analyzed to determine whether to perform network access detection on the target network access point. Therefore, in this manner, filtering out, because of erroneous determining, a target network access point that can access a network is avoided, and accuracy of network access detection is improved.

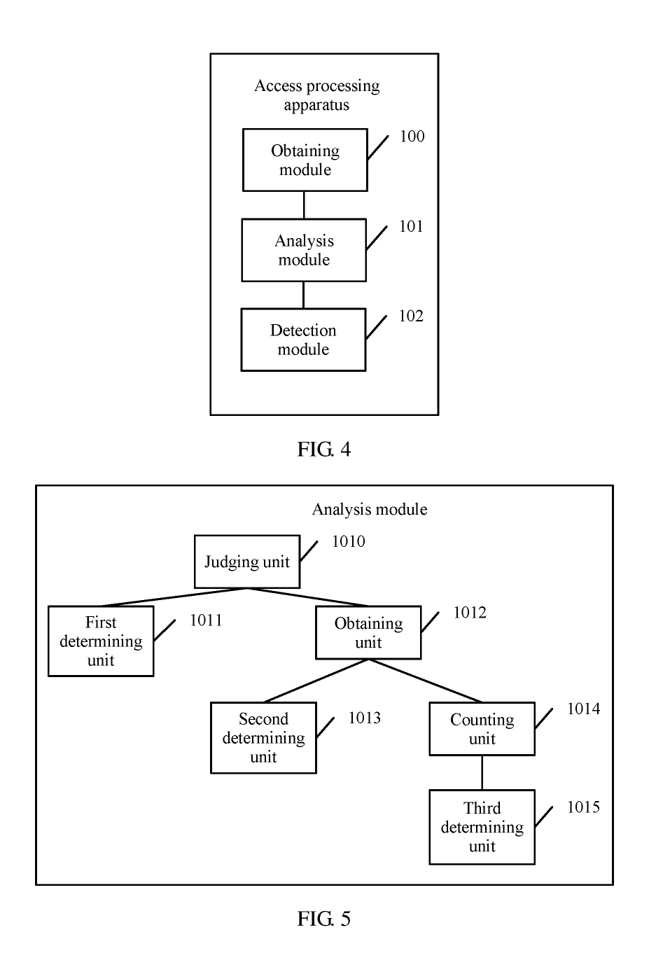

Referring to FIG. 4, FIG. 4 is a schematic structural diagram of an access processing apparatus according to an embodiment of the present disclosure. As shown in FIG. 4, the access processing apparatus in this embodiment may include an obtaining module 100, an analysis module 101, and a detection module 102.

The obtaining module 100 is configured to when it is detected that a target network access point cannot access a network in previous network access detection that is closest to a current moment, obtain network access information of the target network access point before the previous network access detection.

In this embodiment of the present disclosure, a target AP may be any AP for which a terminal pre-stores an AP identifier. Before accessing a network by using the target AP, the terminal needs to perform network access detection on the target AP, that is, detect whether the target AP can access a network. When it is detected that the target AP cannot access a network, the terminal searches for another AP in a preset distance range, or if the target AP can access a network, the terminal accesses the network by using the target AP. In an embodiment, to provide relatively good experience for a user and reduce network access time, before performing network access detection, the terminal automatically filters out an AP that is determined incapable of accessing a network, that is, automatic network access detection is not performed subsequently on an AP that is determined incapable of accessing a network, unless the user manually taps to access the AP. Generally, a method used by a terminal to filter out an AP that is determined incapable of accessing a network is obtaining a detection result for the AP in previous network access detection, and if the AP cannot access a network previously, determining that the AP cannot access a network and automatically filtering out the AP so that the AP is not automatically accessed subsequently any more. If the AP can access a network previously, the AP is automatically accessed and network access detection is performed.

However, because of network congestion or terminal hardware stability, a small probability of erroneous determining may exist in network access detection, that is, an AP that can access a network is detected as an AP that cannot access a network. If it is detected, in network access detection, that an AP cannot access a network, this does not absolutely indicate that the AP is unavailable. Because erroneous determining may exist, considering only a previous network access detection result may cause extremely low accuracy of network access detection.

To resolve the foregoing problem, this embodiment of the present disclosure provides an access processing method, so that a target AP that may be erroneously determined has an opportunity for being reselected for access, and network access detection is re-initiated.

In this embodiment of the present disclosure, a terminal enables Wi-Fi. When it is detected that a target AP cannot access a network in previous network access detection that is closest to a current moment, the obtaining module 100 obtains network access information of the target AP before the previous network access detection. The network access information can indicate multiple network access detection records of the target AP before the previous network access detection, such as whether a network is successfully accessed by using the target AP, or access duration of accessing the network by using the target AP. It should be noted that the network access information may be stored in a newly-added field of a network attribute database of the terminal.

The analysis module 101 is configured to analyze the network access information to determine whether the target network access point has a network access capability.

In this embodiment of the present disclosure, the analysis module 101 analyzes the obtained network access information to further determine whether the target AP has the network access capability. If the target AP has the network access capability, the previous network access detection may be erroneous determining. An analysis method for analyzing the network access information may be determined according to an existing form of the network access information. For example, if the network access information includes multiple network access detection record entries that are used to indicate whether the target AP successfully accesses the network in a detection process before the previous network access detection, an analysis process of analyzing the network access information may be determining whether the network access detection record entries are all successful record entries of successfully accessing the network. If the network access detection record entries are all successful record entries, it is most likely that the previous network access detection is erroneous determining, and the target AP has the network access capability. Further, if the network access detection record entries include an unsuccessful record entry of unsuccessfully accessing the network, a preset quantity of network access detection record entries that are adjacent to the previous network access detection may be obtained. If the preset quantity of network access detection record entries are all successful record entries, it indicates that the previous network access detection may be erroneous determining, and it is determined that the target AP has the network access capability. Still further, if the preset quantity of network access detection record entries include an unsuccessful record entry, a percentage of a successful record entry in all the network access detection record entries may be counted. If the percentage is greater than a preset threshold (such as 50%), it is also determined that the target AP has the network access capability, and the previous network access detection may be erroneous determining.

It should be noted that an analysis manner of analyzing the network access information to determine whether the target AP has the network access capability is not limited to the foregoing example. For example, if the network access information is network access duration of the target AP before the previous network access detection, the analysis manner may further be analyzing the network access duration in the network access information, so as to determine whether the target AP has the network access capability.

The detection module 102 is configured to if the target network access point has the network access capability, automatically access the target network access point, and detect whether the target network access point can currently access the network.

In this embodiment of the present disclosure, if an analysis result of analyzing the network access information indicates that the target AP has the network access capability, the detection module 102 automatically accesses the target AP, and detects whether the target AP can currently access the network. If the target AP can currently access the network, the network is accessed by using the target AP, or if the target AP cannot access the network, another AP is searched for, network access detection is performed on the another AP, and a result of the network access detection is stored so as to be used next time a terminal enables Wi-Fi to filter out an AP.

By using this embodiment of the present disclosure, although the target AP is erroneously determined in network access detection, and it is detected that the target AP cannot access a network, the target AP may not be filtered out directly in a subsequent phase of automatically accessing an AP. The network access information of the target AP before the previous network access detection is analyzed to determine whether the target AP has the network access capability. When it is detected that the target AP has the network access capability, the target AP may also be automatically accessed, and network access detection is performed on the target AP, that is, an error tolerance and recovery method is provided for the target AP.

In this embodiment of the present disclosure, when it is detected that a target network access point cannot access a network in previous network access detection that is closest to a current moment, network access information of the target network access point before the previous network access detection is obtained; the network access information is analyzed to determine whether the target network access point has a network access capability; and if the target network access point has the network access capability, the target network access point is automatically accessed, and it is detected whether the target network access point can currently access the network. In this implementation manner, when it is detected that the target network access point cannot access the network in the previous network access detection, the target network access point is not filtered out directly. The network access information before the previous network access detection is further analyzed to determine whether to perform network access detection on the target network access point. Therefore, in this manner, filtering out, because of erroneous determining, a target network access point that can access a network is avoided, and accuracy of network access detection is improved.

Referring to FIG. 5, FIG. 5 is a schematic structural diagram of an analysis module according to an embodiment of the present disclosure. As shown in FIG. 5, the analysis module in this embodiment may include a judging unit 1010 and a first determining unit 1011.

The judging unit 1010 is configured to determine whether the network access information includes an unsuccessful record entry.

In this embodiment of the present disclosure, the network access information of the target network access point before the previous network access detection may include at least one network access detection record entry before the previous network access detection. The network access detection record entry is used to indicate whether the target AP successfully accesses the network in a network access detection record before the previous network access detection, and the network access detection record entry is a successful record entry or an unsuccessful record entry. In this embodiment of the present disclosure, all historical detection record entries may be stored by using a newly-added field in a network attribute database, and all the historical detection record entries include a detection result of the previous network access detection and the network access detection record entry before the previous network access detection. As shown in FIG. 3, a newly-added field INTERNET_HISTORY is provided in this embodiment of the present disclosure to store all the historical detection record entries. The newly-added field records a maximum of 10 historical detection record entries in total, which may be INTERNET_HISTORY: 0/1/1/1/−1/−1/−1/−1/−1/−1, where on the left is a recent detection result (that is, the detection result of the previous network access detection), and on the right is a farthest detection result. 0 represents that the target AP cannot access the network in network access detection, 1 represents that the target AP can access the network in network access detection, and −1 represents that detection is not performed (there are all −1 in an initial list). In an algorithm, an array may be used to store all the historical detection record entries. For example, h[0] is used to represent a previous detection result, and h[1 . . . 9] is the network access detection record entry before the previous network access detection. Generally, when h[0] is 0, that is, when it is detected that the target AP cannot access the network previously, a subsequent step of obtaining the network access information of the target AP before the previous network access detection is performed.

In this embodiment of the present disclosure, to determine whether the target AP has the network access capability, the judging unit 1010 determines whether the network access information before the previous network access detection includes an unsuccessful record entry. Here, an example in which h[1 . . . 9] is the network access detection record entry in the network access information is still used for description. That is, the network access detection record entry h[1 . . . 9] is traversed from left to right, to obtain a quantity w (w is greater than or equal to 1) of network access detection record entries whose values are not −1 in the array h[1 . . . 9], and determine whether there are all 1 in arrays h[1] to h[w].

The first determining unit 1011 is configured to if the network access information does not include an unsuccessful record entry, determine that the target network access point has the network access capability.

In this embodiment of the present disclosure, if none of the network access detection record entries in the network access information includes an unsuccessful record entry, the first determining unit 1011 determines that the target AP has the network access capability, that is, if there are all 1 in the arrays h[1] to h[w], it is determined that the target AP has the network access capability.

Optionally, the analysis module in this embodiment of the present disclosure may further include an obtaining unit 1012 and a second determining unit 1013.

The obtaining unit 1012 is configured to if the network access information includes an unsuccessful record entry, obtain, in the network access information, a preset quantity of network access detection record entries that are adjacent to the previous network access detection.

In this embodiment of the present disclosure, if the network access detection record entries in the network access information include an unsuccessful record entry, that is, the arrays h[1] to h[w] include 0, the obtaining unit 1012 obtains the preset quantity of network access detection record entries that are adjacent to the previous network access detection. In the network access information, the network access detection record entries are arranged according to a detection time sequence, and the preset quantity of network access detection record entries that are adjacent to the previous network access detection are a preset quantity of network access detection record entries for recent detection except the previous network access detection. The preset quantity may be determined according to a condition, for example, the preset quantity may be two, and values of h[1] and h[2] in the array are obtained.

The second determining unit 1013 is configured to if the preset quantity of network access detection record entries are all successful record entries, determine that the target network access point has the network access capability.

In this embodiment of the present disclosure, if the obtained the preset quantity of network access detection record entries are all successful record entries, the second determining unit 1013 determines that the target AP has the network access capability. If the preset quantity is n (n is less than or equal to w), that is, when h[1] to h[n] are all 1, it is determined that the target AP has the network access capability.

Optionally, the analysis module in this embodiment of the present disclosure may further include a counting unit 1014 and a third determining unit 1015.

The counting unit 1014 is configured to if the historical detection record entries of the preset quantity include an unsuccessful record entry, count a percentage of a successful record entry in the network access information.

In this embodiment of the present disclosure, when the preset quantity of network access detection record entries that are adjacent to the previous network access detection include an unsuccessful record entry, that is, 0 exists in the arrays h[1] to h[n], the counting unit 1014 counts a percentage of a successful record entry in the network access information. A counting method may be calculating a quantity w of network access detection record entries in the network access information, that is, calculating a quantity of values that are not −1 in the array h[1 . . . 9], and calculating a quantity m of successful record entries in the network access information, that is, calculating a quantity of values 1 in the array h[1 . . . 9], and the percentage P of a successful record entry is m/w.

The third determining unit 1015 is configured to if the percentage is greater than a preset threshold, determine that the target network access point has the network access capability.

In this embodiment of the present disclosure, if the calculated percentage P is greater than the preset threshold, the third determining unit 1015 determines that the target AP has the network access capability. The preset threshold may be set according to a condition, for example, may be 60%, or may be 50%.

In this embodiment of the present disclosure, when it is detected that a target network access point cannot access a network in previous network access detection that is closest to a current moment, network access information of the target network access point before the previous network access detection is obtained; the network access information is analyzed to determine whether the target network access point has a network access capability; and if the target network access point has the network access capability, the target network access point is automatically accessed, and it is detected whether the target network access point can currently access the network. In this implementation manner, when it is detected that the target network access point cannot access the network in the previous network access detection, the target network access point is not filtered out directly. The network access information before the previous network access detection is further analyzed to determine whether to perform network access detection on the target network access point. Therefore, in this manner, filtering out, because of erroneous determining, a target network access point that can access a network is avoided, and accuracy of network access detection is improved.

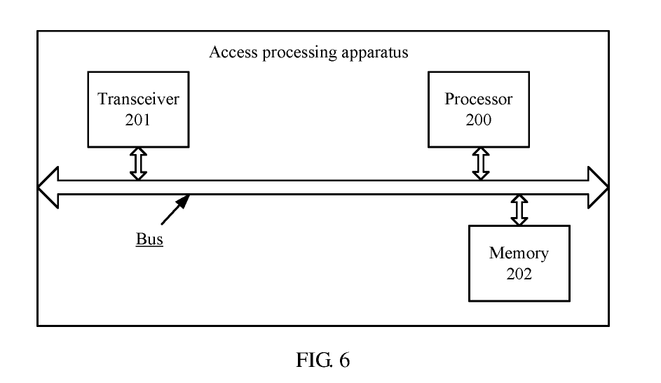

Referring to FIG. 6, FIG. 6 is a schematic structural diagram of another access processing apparatus according to an embodiment of the present disclosure. As shown in FIG. 6, the access processing apparatus in this embodiment includes a processor 200, a transceiver 201, and a memory 202. The memory 202 is configured to store program code, and the processor 200 is configured to invoke the program code in the memory 202 to perform a corresponding operation. The processor 200, the transceiver 201, and the memory 202 are all connected to a bus, and communicate by using the bus.

The processor is configured to when it is detected that a target network access point cannot access a network in previous network access detection that is closest to a current moment, obtain network access information of the target network access point before the previous network access detection.

The processor is further configured to analyze the network access information to determine whether the target network access point has a network access capability.

The processor is further configured to if the target network access point has the network access capability, automatically access the target network access point, and detect whether the target network access point can currently access the network.

Optionally, a target AP may be any AP for which a terminal pre-stores an AP identifier. Before accessing a network by using the target AP, the terminal needs to perform network access detection on the target AP, that is, detect whether the target AP can currently access a network. When it is detected that the target AP cannot currently access a network, the terminal searches for another AP in a preset distance range, or if the target AP can currently access a network, the terminal accesses the network by using the target AP. In an embodiment, to provide relatively good experience for a user and reduce network access time, before performing network access detection, the terminal automatically filters out an AP that is determined incapable of accessing a network, that is, automatic network access detection is not performed subsequently on an AP that is determined incapable of accessing a network, unless the user manually taps to access the AP. Generally, a method used by a terminal to filter out an AP that is determined incapable of accessing a network is obtaining a detection result for the AP in previous network access detection, and if the AP cannot access a network previously, determining that the AP cannot access a network and automatically filtering out the AP so that the AP is not automatically accessed subsequently any more. If the AP can access a network previously, the AP is automatically accessed and network access detection is performed.

However, because of network congestion or terminal hardware stability, a small probability of erroneous determining may exist in network access detection, that is, an AP that can access a network is detected as an AP that cannot access a network. If it is detected, in network access detection, that an AP cannot access a network, this does not absolutely indicate that the AP is unavailable. Because erroneous determining may exist, considering only a previous network access detection result may cause extremely low accuracy of network access detection.

To resolve the foregoing problem, this embodiment of the present disclosure provides an access processing method, so that a target AP that may be erroneously determined has an opportunity for being reselected for access, and network access detection is re-initiated.

In this embodiment of the present disclosure, a terminal enables Wi-Fi. When it is detected that a target AP cannot access a network in previous network access detection that is closest to a current moment, network access information of the target AP before the previous network access detection is obtained. The network access information can indicate multiple network access detection records of the target AP before the previous network access detection, such as whether a network is successfully accessed by using the target AP, or access duration of accessing the network by using the target AP. It should be noted that the network access information may be stored in a newly-added field of a network attribute database of the terminal.

Optionally, the obtained network access information is analyzed to further determine whether the target AP has the network access capability. If the target AP has the network access capability, the previous network access detection may be erroneous determining. An analysis method for analyzing the network access information may be determined according to an existing form of the network access information. For example, if the network access information includes multiple network access detection record entries that are used to indicate whether the target AP successfully accesses the network in a detection process before the previous network access detection, an analysis process of analyzing the network access information may be determining whether the network access detection record entries are all successful record entries of successfully accessing the network. If the network access detection record entries are all successful record entries, it is most likely that the previous network access detection is erroneous determining, and the target AP has the network access capability. Further, if the network access detection record entries include an unsuccessful record entry of unsuccessfully accessing the network, a preset quantity of network access detection record entries that are adjacent to the previous network access detection may be obtained. If the preset quantity of network access detection record entries are all successful record entries, it indicates that the previous network access detection may be erroneous determining, and it is determined that the target AP has the network access capability. Still further, if the preset quantity of network access detection record entries include an unsuccessful record entry, a percentage of a successful record entry in all the network access detection record entries may be counted. If the percentage is greater than a preset threshold (such as 50%), it is also determined that the target AP has the network access capability, and the previous network access detection may be erroneous determining.

It should be noted that an analysis manner of analyzing the network access information to determine whether the target AP has the network access capability is not limited to the foregoing example. For example, if the network access information is network access duration of the target AP before the previous network access detection, the analysis manner may further be analyzing the network access duration in the network access information, so as to determine whether the target AP has the network access capability.

Optionally, if an analysis result of analyzing the network access information indicates that the target AP has the network access capability, the target AP is automatically accessed, and it is detected whether the target AP can access the network. If the target AP can access the network, the network is accessed by using the target AP, or if the target AP cannot access the network, another AP is searched for, network access detection is performed on the another AP, and a result of the network access detection is stored so as to be used next time a terminal enables Wi-Fi to filter out an AP.

By using this embodiment of the present disclosure, although the target AP is erroneously determined in network access detection, and it is detected that the target AP cannot access a network, the target AP may not be filtered out directly in a subsequent phase of automatically accessing an AP. The network access information of the target AP before the previous network access detection is analyzed to determine whether the target AP has the network access capability. When it is detected that the target AP has the network access capability, the target AP may also be automatically accessed, and network access detection is performed on the target AP, that is, an error tolerance and recovery method is provided for the target AP.

The network access information includes at least one network access detection record entry before the previous network access detection, and the network access detection record entry is a successful record entry or an unsuccessful record entry.

The processor is further configured to determine whether the network access information includes an unsuccessful record entry.

The processor is further configured to if the network access information does not include an unsuccessful record entry, determine that the target network access point has the network access capability.

Optionally, the network access information of the target network access point before the previous network access detection may include at least one network access detection record entry before the previous network access detection. The network access detection record entry is used to indicate whether the target AP successfully accesses the network in a network access detection record before the previous network access detection, and the network access detection record entry is a successful record entry or an unsuccessful record entry. In this embodiment of the present disclosure, all historical detection record entries may be stored by using a newly-added field in a network attribute database, and all the historical detection record entries include a detection result of the previous network access detection and the network access detection record entry before the previous network access detection. As shown in FIG. 3, a newly-added field INTERNET_HISTORY is provided in this embodiment of the present disclosure to store all the historical detection record entries. The newly-added field records a maximum of 10 historical detection record entries in total, which may be INTERNET_HISTORY: 0/1/1/1/−1/−1/−1/−1/−1/−1, where on the left is a recent detection result (that is, the detection result of the previous network access detection), and on the right is a farthest detection result. 0 represents that the target AP cannot access the network in network access detection, 1 represents that the target AP can access the network in network access detection, and −1 represents that detection is not performed (there are all −1 in an initial list). In an algorithm, an array may be used to store all the historical detection record entries. For example, h[0] is used to represent a previous detection result, and h[1 . . . 9] is the network access detection record entry before the previous network access detection. Generally, when h[0] is 0, that is, when it is detected that the target AP cannot access the network previously, a subsequent step of obtaining the network access information of the target AP before the previous network access detection is performed.

Optionally, to determine whether the target AP has the network access capability, it is determined whether the network access information before the previous network access detection includes an unsuccessful record entry. Here, an example in which h[1 . . . 9] is the network access detection record entry in the network access information is still used for description. That is, the network access detection record entry h[1 . . . 9] is traversed from left to right, to obtain a quantity w (w is greater than or equal to 1) of network access detection record entries whose values are not −1 in the array h[1 . . . 9], and determine whether there are all 1 in arrays h[1] to h[w].

Optionally, if the historical detection record entries in the network access information do not include an unsuccessful record entry, it is determined that the target AP has the network access capability, that is, if it is determined that there are all 1 in the arrays h[1] to h[w], it is determined that the target AP has the network access capability.

The processor is further configured to if the network access information includes an unsuccessful record entry, obtain, in the network access information, a preset quantity of network access detection record entries that are adjacent to the previous network access detection; and the processor is further configured to if the preset quantity of network access detection record entries are all successful record entries, determine that the target network access point has the network access capability.

Optionally, if the network access detection record entries in the network access information include an unsuccessful record entry, that is, the arrays h[1] to h[w] include 0, the preset quantity of network access detection record entries that are adjacent to the previous network access detection are obtained. In the network access information, the network access detection record entries are arranged according to a detection time sequence, and the preset quantity of network access detection record entries that are adjacent to the previous network access detection are a preset quantity of network access detection record entries for recent detection except the previous network access detection. The preset quantity may be determined according to a condition, for example, the preset quantity may be two, and values of h[1] and h[2] in the array are obtained.

Optionally, if the obtained the preset quantity of network access detection record entries are all successful record entries, it is determined that the target AP has the network access capability. If the preset quantity is n (n is less than or equal to w), that is, when h[1] to h[n] are all 1, it is determined that the target AP has the network access capability.

The processor is further configured to if the preset quantity of network access detection record entries include an unsuccessful record entry, count a percentage of a successful record entry in the network access information.

The processor is further configured to if the percentage is greater than a preset threshold, determine that the target network access point has the network access capability.

Optionally, when the preset quantity of network access detection record entries that are adjacent to the previous network access detection include an unsuccessful record entry, that is, 0 exists in the arrays h[1] to h[n], a percentage of a successful record entry in the network access information is counted. A counting method may be calculating a quantity w of network access detection record entries in the network access information, that is, calculating a quantity of values that are not −1 in the array h[1 . . . 9], and calculating a quantity m of successful record entries in the network access information, that is, calculating a quantity of values 1 in the array h[1 . . . 9], and the percentage P of a successful record entry is m/w.

Optionally, if the calculated percentage P is greater than the preset threshold, it is determined that the target AP has the network access capability. The preset threshold may be set according to a condition, for example, may be 60%, or may be 50%.

In this embodiment of the present disclosure, when it is detected that a target network access point cannot access a network in previous network access detection that is closest to a current moment, network access information of the target network access point before the previous network access detection is obtained; the network access information is analyzed to determine whether the target network access point has a network access capability; and if the target network access point has the network access capability, the target network access point is automatically accessed, and it is detected whether the target network access point can currently access the network. In this implementation manner, when it is detected that the target network access point cannot access the network in the previous network access detection, the target network access point is not filtered out directly. The network access information before the previous network access detection is further analyzed to determine whether to perform network access detection on the target network access point. Therefore, in this manner, filtering out, because of erroneous determining, a target network access point that can access a network is avoided, and accuracy of network access detection is improved.

Persons of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include a magnetic disk, an optical disc, a read-only memory (ROM), or a random access memory (RAM).

What are disclosed above are merely example embodiments of the present disclosure, and certainly are not intended to limit the protection scope of the present disclosure. Therefore, equivalent variations made in accordance with the claims of the present disclosure shall fall within the scope of the present disclosure.

1. An access processing method; comprising:
obtaining network access information of a target network access point before a previous network access detection when it is detected that the target network access point cannot access a network in the previous network access detection that is closest to a current moment;
analyzing the network access information to determine whether the target network access point has a network access capability;
automatically accessing the target network access point when the target network access point has the network access capability; and
detecting whether the target network access point can currently access the network.

2. The method of claim 1, wherein the network access information comprises at least one network access detection record entry prior to the previous network access detection, and wherein the network access detection record entry is a successful record entry or an unsuccessful record entry.

3. The method of claim 2, wherein analyzing the network access information comprises:
determining whether the network access information comprises an unsuccessful record entry; and
determining that the target network access point has the network access capability when the network access information doe not comprise an unsuccessful record entry.

4. The method of claim 3, further comprising:
obtaining, in the network access information, a preset quantity of network access detection record entries that are adjacent to the previous network access detection when the network access information comprises an unsuccessful record entry; and
determining that the target network access point has the network access capability when the preset quantity of network access detection record entries are all successful record entries.

5. The method of claim 4 further comprising:
counting a percentage of a successful record entry in the network access information when the preset quantity of network access detection record entries comprise at least one unsuccessful record entry; and
determining that the target network access point has the network access capability when the percentage is greater than a preset threshold.

6.-10. (canceled)

11. An apparatus, comprising:
one or more processors;
a memory; and
one or more programs stored in the memory, wherein the one or more programs including instructions executable by the one or more processors that cause the apparatus to:
obtain network access information of a target network access point before a previous network access detection when it is detected that the target network access point cannot access a network in the previous network access detection that is closest to a current moment;
analyze the network access information to determine whether the target network access point has a network access capability;
automatically access the target network access point when the target network access point has the network access capability; and
detect whether the target network access point can currently access the network.

12. A non-transitory computer-readable storage medium comprising instructions which when executed by a computer cause the computer to:
obtain network access information of a target network access point before a previous network access detection when it is detected that the target network access point cannot access a network in the previous network access detection that is closest to a current moment;
analyze the network access information to determine whether the target network access point has a network access capability;
automatically access the target network access point when the tar et network access point has the network access capability; and
detect whether the target network access point can currently access the network.
